(19) United States
(12) Patent Application Publication
(10) Pub. No.: US 2026/0371138 A1
(43) Pub. Date: Nov. 19, 2026

(54) ADAPTIVE PERIODIC PERFORMANCE MONITORING SYSTEM FOR AI/ML-BASED USER EQUIPMENT POSITIONING

(71) Applicants: Centre of Excellence in Wireless Technology, Chennai (IN); Indian Institute of Technology Madras (IIT Madras), Chennai (IN)

(72) Inventors: Vikram Krishnakumar, Chennai (IN); Aswathy Subramaniam, Chennai (IN); Anusuya Balasubramanian, Chennai (IN); Abhijeet Abhimanyu Masal, Chennai (IN); Shiv Shankar, Chennai (IN); Jeniston Deviraj Klutto Milleth, Chennai (IN)

(21) Appl. No.: 19/632,254

(22) Filed: Mar. 28, 2026

(30) Foreign Application Priority Data
Mar. 28, 2025 (IN) 202541030088

(51) Int. Cl. H04W 24/10; H04L 41/16; H04W 64/00

(52) U.S. Cl. CPC H04W 24/10; H04L 41/16; H04W 64/00

(57) ABSTRACT

The present invention relates to a method and system for performance monitoring of AI/ML-based User Equipment (UE) positioning in a telecommunication network (1000) by an LMF node (400). The method includes receiving a service request from a network node (500), wherein the service request includes a plurality of attributes. The method further includes starting a periodicity timer based on a periodicity attribute. Upon expiration of the periodicity timer, the method includes initiating the collection of data samples in an area of interest. The method also includes transmitting either a service response comprising the collected data samples to the network node when the LMF node (400) completes the collection of the data samples or an error response to the network node when the LMF node (400) is not able to collect the data samples.

### FIELD OF THE INVENTION

The present invention pertains to telecommunication networks and, more particularly, to an adaptive, periodic performance monitoring system configured to evaluate artificial intelligence or machine learning (AI/ML)-based user equipment positioning within such networks. The application is based on and claims priority from Indian Provisional Application 20/254,1030088 filed on 28^{th} March 2025, the contents of which are incorporated herein by reference.

### BACKGROUND

Fifth-generation (5G) and emerging sixth-generation (6G) systems standardized by the 3rd Generation Partnership Project (3GPP) rely on accurate localization of user equipment (UE) to satisfy regulatory mandates, such as Federal Communications Commission (FCC) emergency call positioning rules, and to support safety-critical and commercial services that demand stringent accuracy, latency, and time-to-first-fix targets. Within a 3GPP-compliant architecture, positioning services are coordinated among the UE, the Radio Access Network (RAN), and the Core Network (CN), with the Location Management Function (LMF) in the CN orchestrating data exchanges with the assistance of Access and Mobility Management Function (AMF) to provide UE location information to external Location Services (LCS) clients or Application Functions (AFs). Traditional LMF-based positioning algorithms are increasingly supplemented by artificial intelligence and machine learning (AI/ML) techniques to meet tightening performance requirements.

AI/ML-driven positioning workflows introduce additional dependencies such as data collection, model training, model deployment, and model performance monitoring. For this purpose, the Network Data Analytics Function (NWDAF) node in the CN assumes responsibility for training and monitoring of AI/ML models used by the LMF. The NWDAF node requires data samples from LMF to perform model training and model performance monitoring. The NWDAF node must discover appropriate LMF instances via the Network Repository Function (NRF), subscribe to measurement data using Nlmf_DataExposure service, and receive data samples that constitutes UE/RAN measurements together with ground-truth indicators. The NWDAF node trains the model, evaluates model accuracy and can trigger retraining by adjusting subscription parameters based on observed errors. This iterative process hinges on timely, well-characterized data delivery from the LMF. The LMF can utilize these trained models for its AI/ML-based positioning operations.

Model performance monitoring is a recurring process. Hence, the NWDAF node requires data samples from LMF at regular intervals of time. Existing Nlmf_DataExposure subscriptions allow the NWDAF node to specify the number of samples, a collection time window, and quality thresholds for ground-truth data, yet they lack an explicit mechanism for defining the periodicity with which the LMF should furnish samples during ongoing model performance monitoring. Consequently, the NWDAF node cannot ensure that data arrives at intervals aligned with its monitoring cadence, forcing ad hoc workarounds or repeated subscription updates. Furthermore, when the LMF cannot satisfy a data request, it currently signals failure using a generic cause code without conveying detailed error information. The NWDAF node is therefore unable to diagnose whether the shortfall stems from insufficient UE measurements, RAN constraints, data-quality issues, or other operational factors, limiting its ability to refine subsequent requests or adjust monitoring strategies. These limitations hinder efficient coordination between the NWDAF node and LMF node, impede reliable AI/ML positioning performance, and hence motivate improvements.

Thus, it is desired to address the above mentioned disadvantages or other shortcomings or at least provide a useful alternative.

### SUMMARY

The principal object of the invention herein is to provide a method for performance monitoring of artificial intelligence/machine learning (AI/ML) based UE positioning in a telecommunication network.

Another object of the invention herein is to provide that the LMF node will offer an attribute to indicate the periodicity of collection of data samples in its Nlmf_DataExposure service when a subscription is created and updated, where the value of this attribute will be in terms of time units.

Yet another object of the invention herein is to provide that in case the LMF node is unable to provide the requested service, then an appropriate error indication will be provided by the LMF node. The error indication scenarios are as follows: sample count is not met due to timer expiry, sample count is not met within the requested time window, the LMF node is unable to continue with data collection due to excess load or congestion, and the LMF node is unable to continue with data collection due to other unspecified reasons.

In an aspect, the present invention provides a method for performance monitoring of artificial intelligence/machine learning (AI/ML) based User Equipment (UE) positioning in a telecommunication network. The method includes receiving, by a location management function (LMF) node, a service request from a network node. The service request includes a plurality of attributes. The plurality of attributes includes an area of interest to collect data samples, a periodicity attribute indicating at least one time interval to initiate the collection of the data samples by the LMF node, a sample count indicating a number of data samples to be collected at every periodicity and a subscription expiry time. The method includes starting, by the LMF node, a periodicity timer based on the periodicity attribute. The method includes initiating, by the LMF node, the collection of the data samples in the area of interest when the periodicity timer expires. The method includes transmitting, by the LMF node, one of a service response comprising the collected data samples to the network node when the LMF node completes the collection of the data samples and an error response to the network node when the LMF node is not able to collect the data samples.

In another aspect, the present invention provides a method for performance monitoring of AI/ML based UE positioning in a telecommunication network. The method includes generating, by a network node, a periodicity attribute indicating at least one time interval for which an LMF node initiates collection of data samples. Further, the method includes transmitting, by the network node, a service request to the LMF node. The service request includes a plurality of attributes. The plurality of attributes includes the periodicity attribute, an area of interest to collect data samples, a sample count indicating a number of data samples to be collected at every periodicity and a subscription expiry time indicating a time at which a subscription for the collection of the data samples expires. Further, the method includes receiving, by the network node from the LMF node, one of a service response including the collected data samples when the LMF node is able to collect the data samples and an error message when the LMF node is not able to collect the data samples.

In yet another aspect, the present invention provides an LMF node for performance monitoring for AI/ML based UE positioning in a telecommunication network. The LMF node includes a processor and a memory including information of a network node. The LMF node includes a data samples collection controller connected to the memory and the processor. The data samples collection controller receives a service request from a network node. The service request includes a plurality of attributes. The plurality of attributes includes an area of interest to collect data samples, a periodicity attribute indicating at least one time interval to initiate the collection of the data samples by the LMF node, and a sample count indicating a number of data samples to be collected at every periodicity and a subscription expiry time. Further, the data samples collection controller starts a periodicity timer based on the periodicity attribute. Further, the data samples collection controller initiates the collection of the data samples in the area of interest when the periodicity timer expires. Further, the data samples collection controller transmits one of a service response including the collected data samples to the network node when the LMF node is able to collect the data samples and an error message to the network node when the LMF node is not able to collect the data samples.

In yet another aspect, the present invention provides a network node for performance monitoring of AI/ML based UE positioning in a telecommunication network. The network node includes a processor and a memory including information of an LMF node. The network node includes a recurrence time controller connected to the memory and the processor. The recurrence time controller generates a periodicity attribute indicating at least one time interval during which an LMF node initiates collection of data samples. Further, the recurrence time controller transmits a service request to the LMF node where the service request includes a plurality of attributes. The plurality of attributes includes the periodicity attribute, an area of interest to collect data samples, and a sample count indicating a number of data samples to be collected at every periodicity and a subscription expiry time indicating a time at which a subscription for the collection of the data samples expires. Further, the recurrence time controller receives from the LMF node one of a service response including the collected data samples to the network node when the LMF node is able to collect the data samples and an error message to the network node when the LMF node is not able to collect the data samples.

In yet another aspect, the present invention provides a method for performance monitoring of AI/ML based UE positioning in a telecommunication network. The method includes receiving, by an LMF node, a service request from a network node to collect data samples by the LMF node for training or performance monitoring of an AI/ML model. The service request includes a plurality of attributes, where the plurality of attributes includes an area of interest from where the data samples are to be collected and at least one of a periodicity attribute indicating at least one time interval during which the LMF node shall initiate the collection of the data samples, a subscription expiry time, and a sample count indicating number of data samples to be collected at every periodicity. Further, the method includes initiating, by the LMF node, the collection of the data samples in the area of interest based on the plurality of attributes. Further, the method includes detecting, by the LMF node, an error when the LMF node is unable to perform collection of data samples. Further, the method includes generating, by the LMF node, an error message including an error cause where the error cause depends on the type of the error. Further, the method includes transmitting, by the LMF node, the error message to the network node. The error cause includes that the sample count is not met due to expiry of a subscription expiry time. In an embodiment, the error cause includes that the sample count is not met within the time window. In an embodiment, the error cause includes that the LMF node is unable to continue with the collection of the data samples due to one of excess load and congestion at the LMF node. In an embodiment, the error cause includes that the LMF node is unable to one of start and complete the collection of the data samples due to one of an internal error and unspecified reasons.

In yet another aspect, the present invention provides an LMF node for performance monitoring of AI/ML based UE positioning in a telecommunication network. The LMF node includes a data samples collection controller connected to a memory and a processor. The data samples collection controller receives a service request from a network node to collect data samples by the LMF node for training or performance monitoring of an AI/ML model. The service request includes a plurality of attributes where the plurality of attributes includes an area of interest from where the data samples are to be collected and at least one of a periodicity attribute indicating at least one time interval during which the LMF node shall initiate the collection of the data samples, a subscription expiry time indicating a time at which a subscription for the collection of the data samples expires, and a sample count indicating a number of data samples to be collected at every periodicity. Further, the data samples collection controller initiates the collection of the data samples in the area of interest based on the plurality of attributes. Further, the data samples collection controller detects an error when the LMF node is unable to perform collection of data samples. Further, the data samples collection controller generates an error message including an error cause where the error cause depends on the type of the error. Further, the data samples collection controller transmits the error message to the network node. The error cause includes that the sample count is not met due to expiry of a subscription expiry time. In an embodiment, the error cause includes that the sample count is not met within the time window. In an embodiment, the error cause includes that the LMF node is unable to continue with the collection of the data samples due to one of excess load and congestion at the LMF node. In an embodiment, the error cause includes that the LMF node is unable to one of start and complete the collection of the data samples due to one of an internal error and unspecified reasons.

These and other aspects of the embodiments will be understood from the following description and drawings, which illustrate preferred embodiments with specific details but do not limit the scope; all modifications within the embodiments are included.

### BRIEF DESCRIPTION OF FIGURES

These and other features, aspects, and advantages of the present invention are illustrated in the accompanying drawings, throughout which like reference letters indicate corresponding parts in the various figures. The embodiments herein will be better understood from the following description with reference to the drawings, in which:

FIG. 1 is a sequence diagram illustrating a procedure for NWDAF node collecting input data samples from the LMF node for ML model training and/or ML model performance monitoring according to prior art

FIG. 2 is a block diagram illustrating an LMF node for performance monitoring for AI/ML based UE positioning in a telecommunication network according to embodiments as disclosed herein

FIG. 3 is a block diagram illustrating a network node for performance monitoring of AI/ML based UE positioning in the telecommunication network according to embodiments as disclosed herein

FIG. 4 is a flow chart illustrating a method implemented by the LMF node for performance monitoring of AI/ML based UE positioning in the telecommunication network according to embodiments as disclosed herein

FIG. 5 is a flow chart illustrating a method implemented by the LMF node for performance monitoring of AI/ML based UE positioning in the telecommunication network according to embodiments as disclosed herein

FIG. 6 is a flow chart illustrating a method implemented by the network node for performance monitoring of AI/ML based UE positioning in a telecommunication network according to embodiments as disclosed herein

FIG. 7A to FIG. 7D are overall example operations of the method for performance monitoring of AI/ML based UE positioning in the telecommunication network according to embodiments as disclosed herein

Like reference numerals denote like elements. The drawings are simplified and not necessarily to scale; certain dimensions can be exaggerated to clarify aspects of the invention. Conventional symbols can be used, and only details pertinent to understanding the embodiments are shown to avoid obscuring information already apparent to skilled artisans.

### DETAILED DESCRIPTION OF INVENTION

The embodiments herein and the various features and advantageous details thereof are explained more fully with reference to the non-limiting embodiments illustrated in the accompanying drawings and described in the following description. Descriptions of well-known components and processing techniques are omitted so as to not unnecessarily obscure the embodiments herein. Further, the various embodiments described herein are not necessarily mutually exclusive, as some embodiments can be combined with one or more other embodiments to form new embodiments. The term “or” as used herein refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is known in the field, embodiments can be described and illustrated in terms of blocks which carry out a described function or functions. These blocks, which can be referred to herein as managers, units, modules, controllers, hardware components or the like, are physically implemented by analog and/or digital circuits such as logic gates, integrated circuits, microprocessors, microcontrollers, memory circuits, passive electronic components, active electronic components, optical components, hardwired circuits and the like, and can optionally be driven by firmware and software. The circuits may, for example, be embodied in one or more semiconductor chips, or on substrate supports such as printed circuit boards and the like. The circuits constituting a block can be implemented by dedicated hardware, or by a processor, such as one or more programmed microprocessors and associated circuitry, or by a combination of dedicated hardware to perform some functions of the block and a processor to perform other functions of the block. Each block of the embodiments can be physically separated into two or more interacting and discrete blocks without departing from the scope of the disclosure. Likewise, the blocks of the embodiments can be physically combined into more complex blocks without departing from the scope of the disclosure. In an embodiment, such blocks are implemented using cooperating hardware circuitry configured to perform control, signaling, data handling, and interface management functions within a mobile communication network.

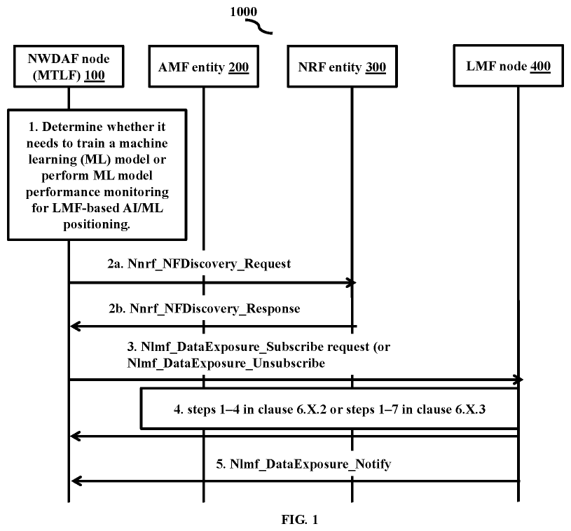

Referring now to the drawings, and more particularly to FIGS. 1 through 7D, where similar reference characters denote corresponding features consistently throughout the figures, there are shown various embodiments.

The mobile communication network consists of three main entities, viz., the user equipment (UE), the radio access network (RAN) and the core network (CN). The CN comprises multiple network functions (NFs), each network function being configured to provide a set of services to other NFs. The network data analytics function (NWDAF) node of the CN is used to collect data from various NFs and provide analytics information. Further, the location management function (LMF) node of the CN plays an important role in determining the location of a UE. The advancement of artificial intelligence/machine learning (AI/ML) and its integration into the mobile communication network benefits various applications of 5G and/or 6G technology. The AI/ML workflow comprises a model lifecycle including training, inference and performance monitoring of the models, which can be used to improve the accuracy of the location estimation of one or more UEs by enhancing the existing positioning algorithm residing at the LMF node (400). In an embodiment, model training and/or model performance monitoring can be performed by the NWDAF node and/or a model training logical function (MTLF), while the LMF node (400) can utilize the trained model for AI/ML-based positioning operations. The NWDAF node containing the AI/ML model(s) training logical function(s) (MTLF) can collect input data samples from the LMF node (400) to obtain AI/ML based positioning. The model performance monitoring can take place in a continuous, periodic or aperiodic manner. However, in existing CN frameworks, there is no adequate provision for an NF service consumer, such as the NWDAF node, to request and obtain data samples from the LMF node (400) at a desired periodicity. Further, there is no adequate support to modify or adapt such periodicity during model performance monitoring. Further, the LMF node (400), acting as an NF service provider, does not provide sufficiently detailed cause information for different error scenarios during service termination and/or data collection failure. This invention focuses on provisioning requester-selectable periodicity and modification of the periodicity for adaptive model performance monitoring via the data exposure service of the LMF node (400). This patent disclosure also elaborates the error handling procedures for training and performance monitoring of the model while using data collection services at the LMF node (400).

FIG. 1 is a sequence diagram illustrating a procedure for NWDAF node (100) collecting the input data samples from the LMF node (400) for ML model training and/or ML model performance monitoring, according to a prior art.

In the prior-art procedure, in step 1, the NWDAF node (100) decides to do model training. In other words, the procedure begins with the NWDAF node (100) or the MTLF determining whether it needs to train a machine learning (ML) model or perform ML model performance monitoring for LMF-based AI/ML positioning. In step 2a and 2b, the NWDAF node (100) discovers an appropriate LMF node (400) using the help of a Network Repository Function (NRF) (300). That is, the NWDAF node (100) initiates network function discovery by sending an Nnrf_NFDiscovery_Request to the Network Repository Function (NRF) (300) in order to identify the appropriate LMF instance. The NRF (300) processes this request and returns an Nnrf_NFDiscovery_Response containing the details of the available LMF node (400).

In step 3, the NWDAF node (100) subscribes to input data samples from the LMF node (400) by invoking the Nlmf_DataExposure subscribe service. This request can include the required number of data samples, time window for the collection of data samples, quality threshold of the ground truth data, data source type (UE or RAN), Notification Target Address to receive data samples, Notification Correlation ID, Area of Interest and expiry time. In step 4, the LMF node (400) collects input data samples from one or more UEs and/or the RAN (steps 1-4 in clause 6.X.2 or steps 1-7 in clause 6.X.3 as per 3GPP specification). In step 5, the LMF node (400) sends the collected data samples containing the input data samples (e.g., location measurement data or the like) from the one or more UEs and/or the RAN, corresponding ground truth information data, that is, location information of the UEs, and quality-related information associated with the ground truth data. In an embodiment, the quality-related information can be represented by a quality indicator value. In case the LMF node (400) fails to meet the NWDAF node (100) request, then the LMF node (400) indicates failure using a cause code.

Once the model is successfully trained by the NWDAF node (100), the NWDAF node (100) can provide the trained model or model-related information to the LMF node (400). Thereafter, the LMF node (400) can execute the trained model to calculate the positioning results. The NWDAF node (100) continues to monitor the model performance. Based on the calculated error from the performance monitoring of the model, the NWDAF node (100) can determine whether to initiate a re-training process. For model monitoring, the NWDAF node (100) again subscribes to the LMF node (400) using the Nlmf_DataExposure subscribe service with parameters including required number of data samples, time window for the collection of data samples, quality threshold of the ground truth data, ML Model Identifier for the ML model, data source type (UE or RAN), Notification Target Address to receive data samples, Notification Correlation ID, Area of Interest and expiry time. In response to this subscription, the LMF node (400) provides data samples. The NWDAF node (100), using these samples, can retrain the trained model. Based on the calculated error from the performance monitoring of the model, the NWDAF node (100) can update the subscription with the LMF node (400) to increase or decrease the time window and/or the number of data samples required. This would be a continuous ongoing process between the LMF node (400) and the NWDAF node (100).

During ML model performance monitoring by the NWDAF node (100) to improve the ML model accuracy, the NWDAF node (100) will need to periodically collect input data samples. For instance, the NWDAF node (100) can want to collect samples every 10 minutes for a specified time window and/or specified number of samples. In the current request for Nlmf_DataExposure, there is an option to specify the time window and the number of data samples, but it does not include a provision to define the periodicity at which the samples should be provided by the LMF node (400). Apart from this, if the LMF node (400) fails to meet the request from NWDAF node (100), then the LMF node (400) indicates failure using a cause code. Currently, the LMF node (400) does not provide sufficiently detailed error cause information to indicate various error scenarios during input data samples collection. Based on this, the NWDAF node (100) can further enhance its future requests towards the LMF node (400). Accordingly, there is a need for a mechanism by which the NWDAF node (100) can request periodic delivery of data samples, modify the requested periodicity during an active subscription, and receive more granular error cause information from the LMF node (400), thereby enabling adaptive model training and adaptive model performance monitoring for AI/ML-based positioning.

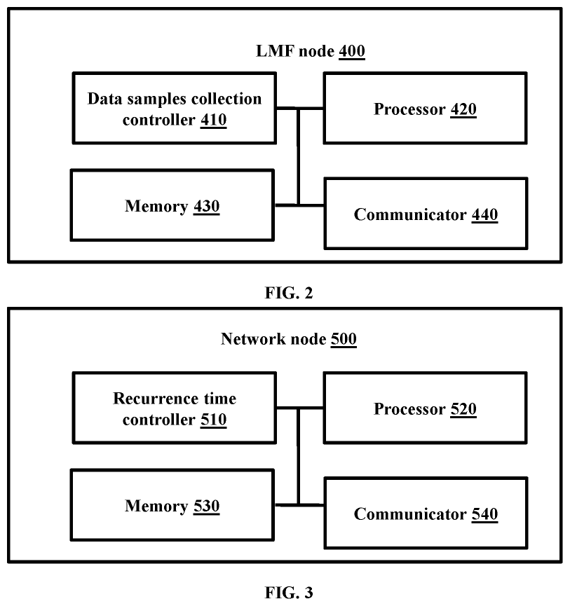

FIG. 2 is a block diagram illustrating an LMF node (400) for performance monitoring for AI and/or ML based UE positioning in a telecommunication network (1000), according to embodiments as disclosed herein. Examples of the telecommunication network (1000) include, but are not limited to, Public Land Mobile Networks (PLMNs) supporting radio access technologies such as 2G, 3G, 4G, 5G, and beyond-5G/6G, and can further include non-terrestrial network (NTN) access via satellite systems. In addition, the telecommunication network (1000) can include, in combination or alternatively, wireless local area networks and machine-type communication networks. The LMF node (400) is a network-side positioning function configured to support location-related signaling towards UE and RAN, UE location information calculation, ground truth data handling, and collection of data samples for training and/or performance monitoring of AI/ML models associated with UE positioning. In an embodiment, the LMF node (400) is implemented as a network function in a core network and can be realized, for example, as a telecom server, a core-network appliance, a blade server, or a virtualized network function deployed on underlying physical hardware.

The LMF node (400) comprises a data samples collection controller (410), a processor (420), a memory (430) storing information associated with a network node (500), and a communicator (440), which are operatively coupled to each other. In an embodiment, the processor (420), the memory (430), the communicator (440), and the data samples collection controller (410) are interconnected through one or more internal buses, interconnects, or interface circuits for coordinated execution of control, signaling, and data handling operations. The processor (420) is configured to execute instructions for controlling operations of the LMF node (400). The memory (430) comprises one or more non-transitory storage media storing node-related information, subscription-related information, collected data samples, ground truth information, and control instructions associated with performance monitoring for AI and/or ML based UE positioning. The communicator (440) is configured to exchange signaling and data with the network node (500) and one or more other entities of the telecommunication network (1000).

The data samples collection controller (410) is implemented as dedicated hardware circuitry operatively coupled to the processor (420), the memory (430), and the communicator (440). In an embodiment, the data samples collection controller (410) includes one or more cooperating hardware blocks comprising a sample request processing circuit, a data aggregation circuit, a quality evaluation circuit, a state management circuit, a message generation and routing circuit, and an interface control circuit. These hardware blocks are configured to collect, filter, organize, and control delivery of data samples associated with UE positioning, maintain collection state information, evaluate quality-related parameters of collected data, and generate signaling or data messages toward the network node (500) and/or other network entities. In an embodiment, the data samples collection controller (410) further includes dedicated logic circuits, register sets, buffer memory, and interface buses for hardware-level control of data sample collection, storage access, and signaling exchange. Such structural hardware implementation enables the data samples collection controller (410) to perform technical control functions associated with AI/ML model training and performance monitoring within the LMF node (400).

The data samples collection controller (410) receives a service request from the network node (500). The network node (500) is one of a Radio Access Network node and a NF of a Core network. The NF of the Core network is one of a NWDAF node (100) and sensing function (SenF) of the Core network. The service request is one of an LMF data exposure subscription create request and an LMF data exposure subscription update request received from the network node using an LMF API. The subscription create, subscription update and notify are sent using HTTP POST, HTTP PATCH and HTTP POST methods respectively. The service request includes a plurality of attributes. The plurality of attributes includes an area of interest to collect data samples, a periodicity attribute indicating at least one time interval to initiate the collection of the data samples by the LMF node (400), a sample count indicating a number of data samples to be collected at every periodicity and a subscription expiry time. The subscription expiry indicates a time at which a subscription for the collection of the data samples expires.

The periodicity attribute is represented as an attribute named “recurTime” in a data structure “LmfDataExposureSubscription” present in the subscription create of Nlmf_DataExposure API. The periodicity attribute includes at least one of the recurrence time window indicating a starting time and an ending time, the recurrence type indicating a recurrence applicable to the recurrence time window, a recurrence month in which the recurrence occurs, a recurrence week indicating a week number of a month in which the recurrence occurs (for example, {1,3} indicates 1st and 3rd week of a month or the like), a recurrence day indicating a day of a week in which the recurrence occurs (for example, recurrence day information element included only if the recurrence type is weekly and monthly_by_day), and a recurrence date indicating a date in which the recurrence occurs (for example, recurrence date information element included only if the recurrence type is monthly_by_day and yearly). The recurrence type comprises one of: integer value and string defined in terms of time units wherein the time units comprise one of “SECONDS,” “MINUTES,” “HOURS,” “DAILY,” “WEEKLY,” “MONTHLY BY DATE,” “MONTHLY BY DAY,” “YEARLY,” “WEEKDAYS ONLY,” and “WEEKENDS ONLY.” Below table 1 indicates an enumeration recurrence type (for example).

TABLE 1

| Enumeration value | Description |
|---|---|
| “DAILY” | Recurrence daily |
| “WEEKLY” | Recurrence weekly |
| “MONTHLY_BY_DATE” | Recurrence monthly by date |
| “MONTHLY_BY_DAY” | Recurrence monthly by day |
| “YEARLY” | Recurrence yearly |
| “WEEKDAYS_ONLY” | Recurrence weekdays only |
| “WEEKENDS_ONLY” | Recurrence weekends only |

Further, the data samples collection controller (410) starts a periodicity timer based on the periodicity attribute, and the data samples collection controller (410) initiates the collection of the data samples in the area of interest when the periodicity timer expires. In an embodiment, the data samples collection controller (410) transmits a service response including the collected data samples to the network node (500) when the LMF node (400) is able to collect the data samples, and the service response uses an LMF data exposure service notify of the LMF API, where the LMF API is the Nlmf_DataExposure API. In overall, for the purpose of ML Model Performance Monitoring, the LMF node (400) provides an attribute to indicate the periodicity of collection of data samples in the Nlmf_DataExposure service, and the value of this attribute is in terms of time units; upon receipt of this subscription indicating periodicity of data collection, the LMF node (400) collects and provides requested data samples in the periodicity specified, and this attribute is also part of an update subscription request enabling the NWDAF node (100) to modify the existing value of periodicity, whereby the LMF node (400) facilitates adaptive periodic model performance monitoring in the NWDAF node (100).

In an embodiment, the data samples collection controller (410) transmits an error message to the network node (500) when the LMF node (400) is not able to collect the data samples. The data samples collection controller (410) determines whether at least one of the collected data samples meets the sample count and the subscription expiry time expired. In an embodiment, the data samples collection controller (410) stops the collection of the data samples, when at least one of the collected data samples meets the sample count and the subscription expiry time expired. In another embodiment, the data samples collection controller (410) continues the collection and transmission of the data samples, when at least one of the collected data samples count does not meets the sample count and the subscription expiry time does not expire.

Further, the data samples collection controller (410) restarts the periodicity timer at the expiry of the periodicity timer based on one of a recurrence type and a recurrence time window, and the data samples collection controller (410) reinitiates the collection and transmission of the data samples in the area of interest when the periodicity timer expires and until at least one of the collected data samples meets the sample count and the subscription expiry time expires.

In an embodiment, the data samples collection controller (410) receives the service request from the network node (500) to collect data samples by the LMF node (400) for training or performance monitoring of the AI/ML model, and the service request includes a plurality of attributes, the plurality of attributes including the area of interest from where the data samples are to be collected and at least one of the periodicity attribute indicating at least one time interval during which the LMF node (400) shall initiate the collection of the data samples, the subscription expiry time, and a sample count indicating data samples to be collected at every periodicity.

Furthermore, the data samples collection controller (410) initiates the collection of the data samples in the area of interest based on the plurality of attributes, and the data samples collection controller (410) detects the error when the LMF node (400) is unable to perform collection of data samples. Further, the data samples collection controller (410) generates the error message including the error cause, where the error cause depends on the type of the error. In an embodiment, the data samples collection controller (410) determines that a current sample count at the LMF node (400) is less than the sample count requested in the service request after expiry of the subscription expiry time, and the data samples collection controller (410) generates the error comprising the error cause indicating the sample count is not met due to expiry of the subscription expiry time for the collection of the data samples.

In an embodiment, the data samples collection controller (410) determines that the current sample count at the LMF node (400) is less than the sample count requested in the service request within the time window requested in the service request, and the data samples collection controller (410) generates the error message comprising the error cause indicating the sample count is not met within the time window. In an embodiment, the data samples collection controller (410) determines whether one of an excess load and congestion at the LMF node (400) meets a threshold, and the data samples collection controller (410) generates the error message comprising the error cause indicating the LMF node (400) is unable to continue with the collection of the data samples due to excess load or congestion at the LMF node (400).

In an embodiment, the data samples collection controller (410) detects one of an internal error and other unspecified errors at the LMF node (400), and the data samples collection controller (410) generates the error message comprising the error cause indicating the LMF node (400) is unable to start or continue with the collection of the data samples due to internal error or unspecified reasons.

Further, the data samples collection controller (410) transmits the error message to the network node (500), and the error cause includes at least one of that the sample count is not met due to expiry of the subscription expiry time, the sample count is not met within the time window, the LMF node (400) is unable to continue with the collection of the data samples due to one of excess load and congestion at the LMF node (400), and the LMF node (400) is unable to one of start and complete the collection of the data samples due to one of an internal error and unspecified reasons.

In case the LMF node (400) is unable to provide the requested service, then an appropriate error indication will be provided by the LMF (400). The following scenarios, along with the corresponding error causes to be sent by LMF (400), are mentioned below:
a) If the sample count is not met due to timer expiry, then the LMF node (400) will send an error cause code to the NWDAF node (100) mentioning a reason that the requested number of samples are not met due to expiry in timer value.
b) If the sample count is not met within the requested time window, then the LMF node (400) will send an error response to the NWDAF node (100) mentioning a reason that the requested number of samples are not met due to expiry in time window value.
c) If the LMF node (400) is unable to continue with data collection due to excess load or congestion, then the LMF will send an error response to NWDAF node (100) mentioning a reason that the created subscription is terminated due to overload and further terminates the subscription.
d) If the LMF node (400) is unable to continue with data collection due to other unspecified reasons, then the LMF will send an error response to the NWDAF node (100) mentioning that the created subscription is terminated due to other reasons.

Each error cause is represented as an attribute “cause” in a data type “LmfDataExposureCause” present in the Nlmf_DataExposure API, and wherein the data type “LmfDataExposureCause” is updated to include additional error causes.

The addition of a new feature provided in the Nlmf_DataExposure service API of the LMF node (400) shall enable the LMF node (400) to periodically provide measurement information to the NF service consumer (e.g., NWDAF node (100)) when a subscription is created or modified for the purpose of ML Model Performance Monitoring. Also, in case the LMF node (400) is unable to provide service, then appropriate error indication will be provided by the LMF node (400) along with its corresponding failure reason.

FIG. 3 is a block diagram illustrating the network node (500) for performance monitoring of AI/ML based UE positioning in the telecommunication network (1000), according to embodiments as disclosed herein. The network node (500) is one of a Radio Access Network node or a NF of a Core network. The NF of the Core network is one of a NWDAF node (100) or a SenF of the Core network. The network node (500) is configured to request, control, and/or adapt collection periodicity of data samples associated with AI/ML based UE positioning, and to exchange signaling with the LMF node (400) for model training and/or model performance monitoring. In an embodiment, the network node (500) is implemented as a network equipment platform or network function of core network and can be realized as a radio access network device, a core-network server, a network appliance, or a virtualized network function deployed on underlying physical hardware. The network node (500) includes a recurrence time controller (510), a processor (520), a memory (530) storing information associated with the LMF node (400), and a communicator (540), which are operatively coupled to each other.

The processor (520) communicates with the memory (530), the communicator (540), and the recurrence time controller (510). The processor (520) is configured to execute instructions stored in the memory (530) and to perform various processes. The processor (520) can include one or a plurality of processors, and can be implemented as a general-purpose processor such as a central processing unit (CPU), an application processor (AP), or the like, a graphics-only processing unit such as a graphics processing unit (GPU), a visual processing unit (VPU), and/or an Artificial Intelligence (AI) dedicated processor such as a neural processing unit (NPU). In an embodiment, the processor (520) is configured to control service request generation, subscription management, recurrence-time adaptation, and handling of responses received from the LMF node (400).

The memory (530) is configured to store instructions to be executed by the processor (520). The memory (530) includes an AI and/or ML model. The AI and/or ML model can be, for example, but not limited to a Handover Success Prediction Neural Network (HSP-NN), a Deep Neural Network (DNN), a Long Short-Term Memory (LSTM) Network, a Random Forest Classifier, a Gradient Boosting Model, a Reinforcement Learning (RL) Agent, a Support Vector Machine (SVM), a reinforcement learning-based policy engine, or the like. The memory (530) can include non-volatile storage elements. Examples of such non-volatile storage elements can include magnetic hard disks, optical disks, floppy disks, flash memories, or forms of electrically programmable memories (EPROM) or electrically erasable and programmable (EEPROM) memories. In addition, the memory (530) can in some examples be considered a non-transitory storage medium. The term non-transitory can indicate that the storage medium is not embodied in a carrier wave or a propagated signal. However, the term non-transitory should not be interpreted to mean that the memory is non-movable. In some examples, the memory (530) can be configured to store larger amounts of information. In certain examples, a non-transitory storage medium can store data that can over time change, for example, in Random Access Memory (RAM) or cache. In an embodiment, the memory (530) further stores subscription-related information, periodicity-related parameters, area-of-interest information, expiry-time information, data samples received from the LMF node (400), and error information associated with service responses.

The communicator (540) includes an electronic circuit specific to a standard that enables wired or wireless communication. The communicator (540) is configured to communicate internally between internal hardware components of the network system and with external devices via one or more networks. In an embodiment, the communicator (540) is configured to transmit a service request to the LMF node (400) and receive a service response, collected data samples, and/or an error message from the LMF node (400).

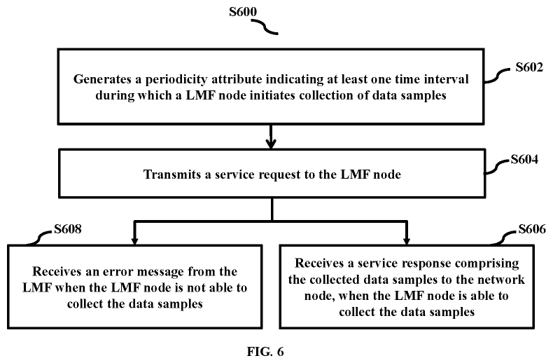

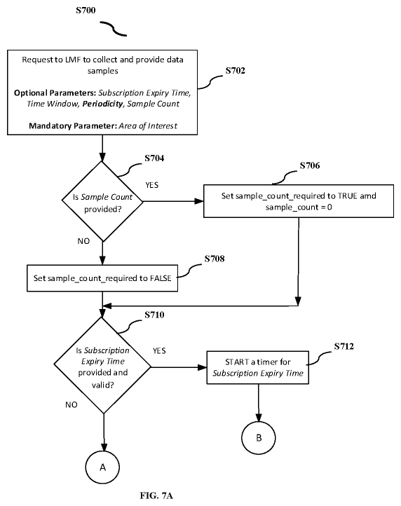

The recurrence time controller (510) is implemented by dedicated processing circuitry such as logic gates, integrated circuits, microprocessors, microcontrollers, memory circuits, passive electronic components, active electronic components, optical components, hardwired circuits, or the like. The circuits may, for example, be embodied in one or more semiconductors. In an embodiment, the recurrence time controller (510) is operatively coupled to the processor (520), the memory (530), and the communicator (540), and includes one or more cooperating hardware blocks comprising a periodicity determination circuit, a request generation circuit, a parameter update circuit, a state management circuit, and an interface control circuit. The recurrence time controller (510) implements the solution as described above with respect to FIG. 6. In an embodiment, the recurrence time controller (510) further includes dedicated logic circuits, register sets, buffer memory, and interface buses for hardware-level control of recurrence-time determination, request formation, and signaling exchange with the LMF node (400).

The recurrence time controller (510) generates the periodicity attribute indicating at least one time interval for which the LMF node (400) initiates collection of data samples. Further, the recurrence time controller (510) transmits the service request to the LMF node (400), where the service request includes a plurality of attributes. The plurality of attributes includes the periodicity attribute, the area of interest to collect data samples, and the sample count indicating a number of data samples to be collected at every periodicity and the subscription expiry time indicating a time at which a subscription for the collection of the data samples expires. Further, the recurrence time controller (510) receives, from the LMF node (400), either the service response comprising the collected data samples, when the LMF node (400) is able to collect the data samples, or an error message when the LMF node (400) is not able to collect the data samples. In an embodiment, the recurrence time controller (510) is further configured to modify the periodicity attribute based on model performance monitoring requirements and to generate an updated service request for adaptive collection of data samples from the LMF node (400).

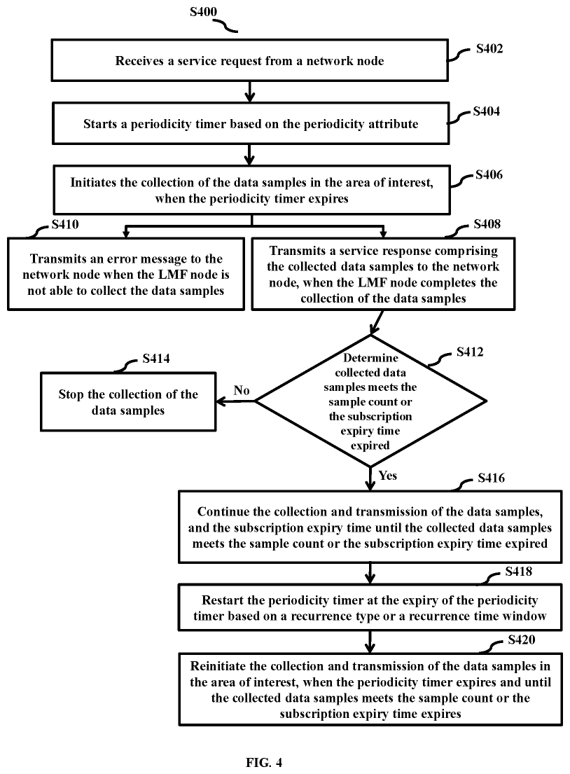

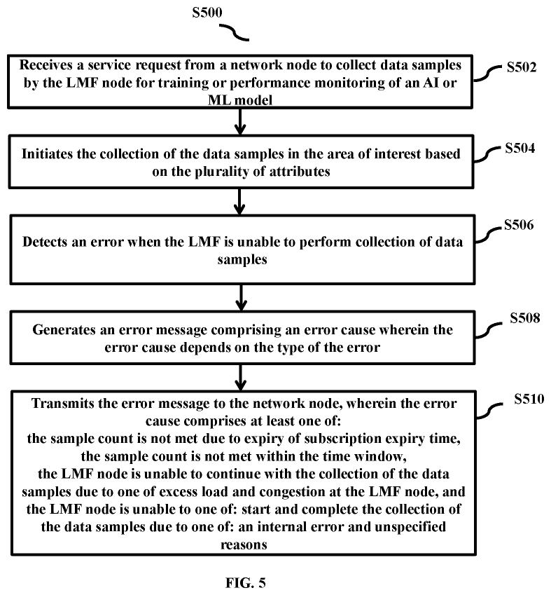

FIG. 4 is a flow chart (S400) illustrating a method implemented by the LMF node (400) for performance monitoring of AI/ML-based UE positioning in the telecommunication network (1000) according to embodiments disclosed herein, and the operations (S402-S420) are handled by the data samples collection controller (410). At S402, the method includes receiving the service request from the network node (500), and the service request includes the plurality of attributes, with the plurality of attributes including the area of interest to collect data samples, the periodicity attribute indicating at least one time interval to initiate the collection of the data samples by the LMF node (400), and the sample count indicating the number of data samples to be collected at every periodicity and the subscription expiry time. At S404, the method includes starting the periodicity timer based on the periodicity attribute. At S406, the method includes initiating, by the LMF node, the collection of the data samples in the area of interest when the periodicity timer expires. At S408, the method includes transmitting the service response comprising the collected data samples to the network node (500) when the LMF node completes the collection of the data samples. At S410, the method includes transmitting the error response to the network node when the LMF node (400) is not able to collect the data samples.

At S412, the method includes determining whether at least one of the collected data samples meets the sample count and the subscription expiry time expired. At S414, the method includes stopping the collection of the data samples, when at least one of the collected data samples meets the sample count and the subscription expiry time expired. At S416, the method includes continuing the collection and transmission of the data samples, and the subscription expiry time until at least one of the collected data samples meets the sample count and the subscription expiry time expired, when at least one of the collected data samples does not meets the sample count and the subscription expiry time does not expire.

At S418, the method includes restarting the periodicity timer at the expiry of the periodicity timer based on one of: the recurrence type and the recurrence time window. At S420, the method includes reinitiating the collection and transmission of the data samples in the area of interest, when the periodicity timer expires and until at least one of the collected data samples meets the sample count and the subscription expiry time expires.

FIG. 5 is a flow chart (S500) illustrating a method implemented by the LMF node (400) for performance monitoring of AI- or ML-based UE positioning in the telecommunication network (1000) according to embodiments disclosed herein, and the operations (S502-S510) are handled by the data samples collection controller (410). At S502, the method includes receiving the service request from the network node (500) to collect data samples by the LMF node (400) for training or performance monitoring of the AI/ML model, and the service request includes the plurality of attributes where the plurality of attributes includes the area of interest from where the data samples are to be collected and at least one of a periodicity attribute indicating at least one time interval during which the LMF node shall initiate the collection of the data samples, the subscription expiry time, and the sample count indicating number of data samples to be collected at every periodicity. At S504, the method includes initiating the collection of the data samples in the area of interest based on the plurality of attributes. At S506, the method includes detecting the error when the LMF node (400) is unable to perform collection of data samples. At S508, the method includes generating the error message including an error cause where the error cause depends on the type of the error. At S510, the method includes transmitting by the LMF node the error message to the network node (500). The error cause includes that the sample count is not met due to expiry of subscription expiry time. In an embodiment, the error cause includes that the sample count is not met within the time window. In an embodiment, the error cause includes that the LMF node (400) is unable to continue with the collection of the data samples due to one of excess load and congestion at the LMF node (400). In an embodiment, the error cause includes that the LMF node (400) is unable to one of start and complete the collection of the data samples due to one of an internal error and unspecified reasons.

Unlike to existing system, the LMF node (400) cross-checks the received attributes against policy constraints or regulatory requirements before initiating data collection. This verification can include validating that the requested area of interest falls within authorized geographic zones, confirming that the subscription expiry time has not lapsed, and ensuring that the requested sample count does not exceed pre-negotiated quotas. If any constraint is violated, the data samples collection controller (410) can proactively generate an error message with a specific error cause, thereby reducing unnecessary resource allocation and providing the network node (500) with immediate feedback for corrective action.

Unlike the existing system, the present invention includes adaptive adjustment of the periodicity timer in response to dynamic network conditions or revised service-level agreements. For example, when the network node (500) issues an updated service request that modifies the periodicity attribute or the required sample count, the data samples collection controller (410) can reconfigure the timer without restarting the entire procedure, thereby preserving continuity of the monitoring session. Further, the LMF node (400) can maintain a historical log of prior periodicity expirations and corresponding collection outcomes, enabling predictive scheduling that anticipates congestion windows or maintenance intervals within the telecommunication network (1000).

FIG. 6 is a flow chart (S600) illustrating a method implemented by the network node (500) for performance monitoring of AI/ML-based UE positioning in the telecommunication network (1000) according to embodiments disclosed herein, and the recurrence time controller (510) handles operations (S602-S608). At S602, the method includes generating the periodicity attribute indicating the at least one time interval for which the LMF node (400) initiates collection of data samples. At S604, the method includes transmitting the service request to the LMF node (400), and the service request includes the plurality of attributes. The plurality of attributes includes the periodicity attribute, the area of interest to collect data samples, and the sample count indicating a number of data samples to be collected at every periodicity and the subscription expiry time. At S606, the method includes receiving the service response including the collected data samples to the network node when the LMF node (400) is able to collect the data samples. At S608, the method includes receiving an error message when the LMF node (400) is not able to collect the data samples.

Unlike to the existing system, the network node (500) can optionally implement a feedback loop that adjusts the periodicity attribute based on the quality or completeness of the data samples received from the LMF node (400). For instance, if the service response indicates that the collected samples exhibit insufficient geographic diversity or fail to meet accuracy thresholds for AI/ML model training, the recurrence time controller (510) can shorten the time interval or request additional sampling bursts in targeted sub-areas. Conversely, when the LMF node reports congestion or partial fulfillment, the network node can elongate the interval or temporarily suspend requests, thereby harmonizing resource usage between the LMF node and other network functions.

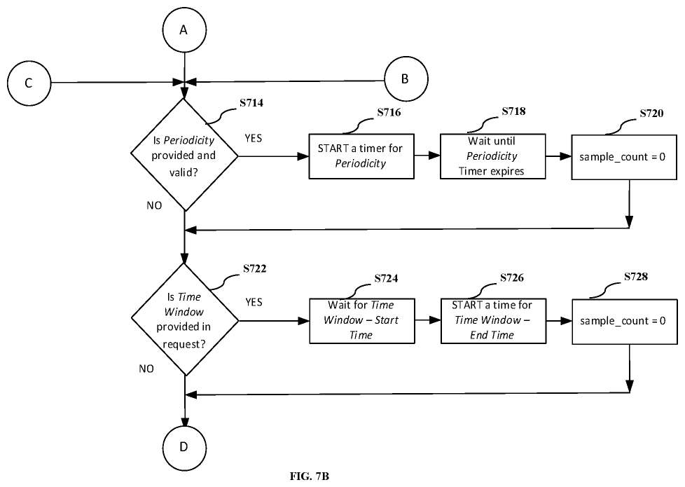

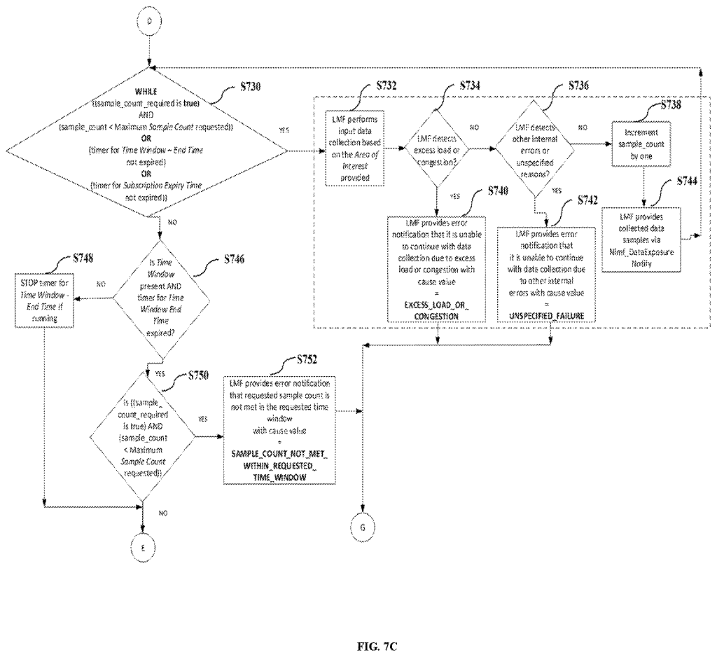

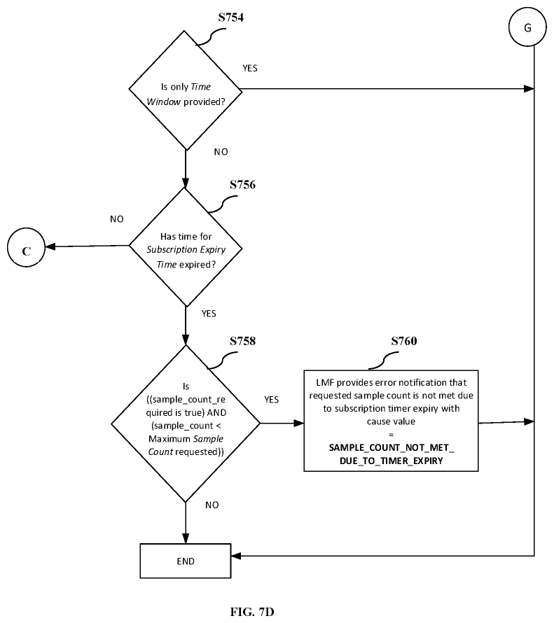

FIG. 7A to FIG. 7D are overall operations (S700) of the method for performance monitoring of AI/ML based UE positioning in the telecommunication network (1000), according to embodiments as disclosed herein. The operations (S702-S760) are handled by the data samples collection controller (410) of the LMF node (400).

At S702, the procedure begins when the NWDAF node (100) requests the LMF node (400) to collect and provide the data samples based on optional parameters such as a required number of data samples, reporting time window, reporting periodicity, and subscription expiry time, and a mandatory parameter such as area of interest. At S704, the LMF node (400) first evaluates whether a sample count is included in the request. If provided, at S706, the LMF node (400) sets the required sample count accordingly and initializes a sample counter, otherwise at S708, the LMF node (400) assigns the sample count required as false.

At S710, the LMF node (400) then checks if a subscription expiry time is provided and valid. If the subscription expiry time is specified and valid, then at S712, the LMF node (400) starts a subscription expiry timer. At S714, the LMF node (400) then checks if the reporting periodicity is provided and valid. If the reporting periodicity is provided and valid, at S716, the LMF node (400) starts a reporting periodicity timer. At S718, the LMF node (400) waits until the reporting periodicity timer expires. At S720, the current sample count is initialized or reset to zero for a reporting cycle. The subscription expiry timer can be synchronized with the NWDAF node (100) using Network Time Protocol (NTP) to avoid drift that could prematurely terminate data collection. Reporting periodicity values can range from seconds to years, and the LMF node (400) enforces minimum and maximum thresholds to maintain compliance with service-level agreements.

If the reporting periodicity is not provided or is not valid, at S722, the LMF node (400) checks whether the time window is provided in the request. The mapping the time window and periodicity as per 3GPP specification defined attributes has to be done. If the time window is provided in the request, at S724, the LMF node (400) waits for a time window start time. At S726, the LMF node (400) starts a time window end timer. At S728, the current sample count is initialized or reset to zero.

At S730, the LMF node (400) checks whether data collection is to continue based on one or more of: ((sample_count_required is true) AND (sample_count<requested sample count)) OR (timer for time window end time not expired) OR (timer for subscription expiry time not expired).

At S732, the LMF node (400) performs input data samples collection based on the area of interest provided. At S734, the LMF node (400) detects whether there is excess load or congestion. If the LMF node (400) detects excess load or congestion, then at S740, the LMF node (400) provides an error notification that it is unable to continue with data collection due to excess load or congestion with cause value=EXCESS LOAD OR CONGESTION. If the LMF node (400) does not detect excess load or congestion, then at S736, the LMF node (400) detects whether there are other internal errors or unspecified reasons. If the LMF node (400) detects other internal errors or unspecified reasons, then at S742, the LMF node (400) provides an error notification that it is unable to continue with data collection due to other internal errors with cause value=UNSPECIFIED FAILURE. If the LMF node (400) does not detect other internal errors or unspecified reasons, then at S744, the LMF node (400) provides collected data samples via Nlmf_DataExposureNotify, and at S746, the LMF node (400) increments the sample count by one. Whenever an error is detected and sent by the LMF node (400) for any cause, the data collection process at the LMF node (400) terminates. The area of interest can correspond to a polygonal geofence, and the LMF node (400) filters UE measurements using geospatial indexing to ensure only relevant samples are captured. Load detection leverages CPU utilization thresholds and message queue depths, triggering the EXCESS_LOAD_OR_CONGESTION cause when predefined limits are exceeded. When transmitting samples via Nlmf_DataExposureNotify, data samples collection controller (410) can batch multiple records to reduce signaling overhead while preserving per-sample integrity through sequence numbers.

At S748, the LMF node (400) determines whether the time window is present and whether the timer for the time window end time has expired. If yes, the LMF node (400) checks if the requested sample count has not been met within the requested time window, the LMF node (400) can provide an error notification with cause value=SAMPLE_COUNT_NOT_MET_WITHIN_REQUESTED_TIME_WIND OW. If no, the LMF node (400) determines whether ((sample_count_required is true) AND (sample_count<requested sample count)) so that data collection can continue. Data samples collection controller (410) can also include in the error notification the actual number of samples collected and the elapsed time to aid NWDAF node (100) in adjusting future requests. When the time window expires, the LMF node (400) archives the session context for compliance reporting before resetting timers. If the sample count condition remains unmet but the window is still open, data samples collection controller (410) can escalate sampling frequency by prioritizing UEs with higher positioning uncertainty.

At S754, the LMF node (400) determines whether only the time window is provided. If no, at S756, the LMF node (400) determines whether the subscription expiry timer has expired. If the subscription expiry timer has expired, at S758, the LMF node (400) determines whether ((sample_count_required is true) AND (sample_count<requested sample count)). If yes, the LMF node (400) provides an error notification that the requested sample count is not met due to subscription timer expiry with cause value=SAMPLE_COUNT_NOT_MET_DUE_TO_TIMER_EXPIRY. In scenarios where both time window and subscription expiry are absent, the LMF node (400) can default to continuous monitoring until explicitly terminated by the NWDAF node (100). Upon subscription expiry, data samples collection controller (410) flushes any pending samples to persistent storage to prevent data loss before issuing the error notification. The notification can include a recommended extension duration derived from historical sampling rates, enabling the NWDAF node (100) to reissue a more achievable request.

The various actions, acts, blocks, steps, or the like in the flow charts (S400-S700) can be performed in the order presented, in a different order, or simultaneously. Further, in some embodiments, some of the actions, acts, blocks, steps, or the like can be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and therefore such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

We claim:

1. A method for performance monitoring of artificial intelligence/machine learning (AI/ML) based User Equipment (UE) Positioning in a telecommunication network (1000), comprising:
receiving, by a location management function (LMF) node (400), a service request from a network node (500), wherein the service request comprises a plurality of attributes, wherein the plurality of attributes comprises an area of interest to collect data samples, a periodicity attribute indicating at least one time interval to initiate the collection of the data samples by the LMF node (400), a sample count indicating a number of data samples to be collected at every periodicity, and a subscription expiry time;
starting, by the LMF node (400), a periodicity timer based on the periodicity attribute;
initiating, by the LMF node (400), the collection of the data samples in the area of interest, when the periodicity timer expires; and
transmitting, by the LMF node (400), one of:
a service response comprising the collected data samples to the network node (500), when the LMF node (400) completes the collection of the data samples, and
an error response to the network node (500) when the LMF node (400) is not able to collect the data samples.

2. The method as claimed in claim 1, comprises:
determining, by the LMF node (400), whether at least one of the collected data samples meets the sample count and the subscription expiry time expired; and
performing, by the LMF node (400), one of:
stopping the collection of the data samples, when at least one of the collected data samples meets the sample count and the subscription expiry time expired; and
continuing, by the LMF node (400), the collection and transmission of the data samples, and the subscription expiry time until at least one of the collected data samples meets the sample count and the subscription expiry time expired, when at least one of the collected data samples does not meets the sample count and the subscription expiry time does not expire.

3. The method as claimed in claim 1, comprises:
restarting, by the LMF node (400), the periodicity timer at the expiry of the periodicity timer based on one of: a recurrence type and a recurrence time window; and
reinitiating, by the LMF node (400), the collection and transmission of the data samples in the area of interest, when the periodicity timer expires and until at least one of the collected data samples meets the sample count and the subscription expiry time expires.

4. The method as claimed in claim 1, wherein the service request is one of: a LMF data exposure subscription create request and a LMF data exposure subscription update request received from the network node (500) using a LMF API, and wherein the service response is using a LMF data exposure service notify of the LMF API, and where the LMF API is Nlmf_DataExposure API.

5. The method as claimed in claim 1, wherein the periodicity attribute is represented as an attribute named “recurTime” in a data structure “LmfDataExposureSubscription” present in the subscription create of Nlmf_DataExposure API.

6. The method as claimed in claim 1, wherein the periodicity attribute comprises at least one of the recurrence time window indicating a starting time and an ending time, a recurrence type indicating a recurrence applicable to the recurrence time window, a recurrence month in which the recurrence occurs, a recurrence week indicating a week number of a month in which the recurrence occurs, a recurrence day indicating a day of a week in which the recurrence occurs, and a recurrence date indicating a date in which the recurrence occurs.

7. The method as claimed in claim 6, wherein the recurrence type comprises one of integer value and string defined in terms of time units, wherein the time units comprises one of “SECONDS”, “MINUTES”, “HOURS”, “DAILY”, “WEEKLY”, “MONTHLY BY DATE”, “MONTHLY BY DAY”, “YEARLY”, “WEEKDAYS ONLY”, and “WEEKENDS ONLY”.

8. A method for performance monitoring of artificial intelligence/machine learning (AI/ML) based User Equipment (UE) Positioning in a telecommunication network (1000), comprising:
generating, by a network node (500), a periodicity attribute indicating at least one time interval for which a LMF node (400) initiates collection of data samples;
transmitting, by the network node (500), a service request to the LMF node (400), wherein the service request comprises a plurality of attributes, wherein the plurality of attributes comprises the periodicity attribute, an area of interest to collect data samples, a sample count indicating a number of data samples to be collected at every periodicity, and a subscription expiry time; and
receiving, by the network node (500) from the LMF node (400), one of:
a service response comprising the collected data samples, when the LMF node (400) is able to collect the data samples, and
an error message when the LMF node (400) is not able to collect the data samples.

9. The method as claimed in claim 8, wherein the service request is one of: a LMF data exposure subscription create request and a LMF data exposure subscription update request received from the network node (500) using a LMF API, and wherein the service response is using a LMF data exposure service notify of the LMF API, and where the LMF API is Nlmf_DataExposure API.

10. The method as claimed in claim 8, wherein the periodicity attribute is represented as an attribute named “recurTime” in a data structure “LmfDataExposureSubscription” present in the subscription create of Nlmf_DataExposure API.

11. The method as claimed in claim 8, wherein the periodicity attribute comprises at least one of a recurrence time window indicating a starting time and an ending time, a recurrence type indicating a recurrence applicable to the recurrence time window, a recurrence month in which the recurrence occurs, a recurrence week indicating a number of weeks in which the recurrence occurs, a recurrence day indicating a day of a week in which the recurrence occurs, and a recurrence date indicating a data in which the recurrence occurs, and wherein the recurrence type comprises one of integer value and string defined in terms of time units, wherein the time units comprises one of SECONDS″, “MINUTES”, “HOURS”, “DAILY”, “WEEKLY”, “MONTHLY BY DATE”, “MONTHLY BY DAY”, “YEARLY”, “WEEKDAYS ONLY”, and “WEEKENDS ONLY”.

12. A Location Management Function (LMF) node (400) for performance monitoring for artificial intelligence or machine learning (AI/ML) based User Equipment (UE) Positioning in a telecommunication network (1000), comprising:
a memory (430) comprising information of a network node (500);
a processor (420); and
a data samples collection controller (410), connected to the memory (430) and the processor (420), wherein the data samples collection controller (410):
receives a service request from a network node (500), wherein the service request comprises a plurality of attributes, wherein the plurality of attributes comprises an area of interest to collect data samples, a periodicity attribute indicating at least one time interval to initiate the collection of the data samples by the LMF node (400), a sample count indicating a number of data samples to be collected at every periodicity, and a subscription expiry time;
starts a periodicity timer based on the periodicity attribute;
initiates the collection of the data samples in the area of interest, when the periodicity timer expires; and
transmits one of:
a service response comprising the collected data samples to the network node (500), when the LMF node (400) is able to collect the data samples, and
an error message to the network node (500) when the LMF node (400) is not able to collect the data samples.

13. A network node (500) for performance monitoring of artificial intelligence/machine learning (AI/ML) based User Equipment (UE) Positioning in a telecommunication network (1000), comprising:
a memory (530) comprising information of a Location Management Function (LMF) node (400);
a processor (520); and
a recurrence time controller (510), connected to the memory and the processor, wherein the recurrence time controller (510):
generates a periodicity attribute indicating at least one time interval during which a LMF node (400) initiates collection of data samples;
transmits a service request to the LMF node (400), wherein the service request comprises a plurality of attributes, wherein the plurality of attributes comprises the periodicity attribute, an area of interest to collect data samples, a sample count indicating a number of data samples to be collected at every periodicity, and a subscription expiry time; and
receives from the LMF node (400), one of:
a service response comprising the collected data samples to the network node (500), when the LMF node (400) is able to collect the data samples, and
an error message to the network node (500), when the LMF node (400) is not able to collect the data samples.

14. A method for performance monitoring of artificial intelligence or machine learning (AI/ML) based User Equipment (UE) Positioning in a telecommunication network (1000), comprising:
receiving, by a Location Management Function (LMF) node (400), a service request from a network node (500) to collect data samples by the LMF node (400) for training or performance monitoring of an AI/ML model, wherein the service request comprises a plurality of attributes, wherein the plurality of attributes comprises an area of interest from where the data samples are to be collected, and at least one of a periodicity attribute indicating at least one time interval during which the LMF node (400) shall initiate the collection of the data samples, a subscription expiry time, and a sample count indicating number of data samples to be collected at every periodicity;
initiating, by the LMF node (400), the collection of the data samples in the area of interest based on the plurality of attributes;
detecting, by the LMF node (400), an error when the LMF node (400) is unable to perform collection of data samples;
generating, by the LMF node (400), an error message comprising an error cause wherein the error cause depends on a type of the error; and
transmitting, by the LMF node (400), the error message to the network node (500), wherein the error cause comprises at least one of:
a) the sample count is not met due to expiry of subscription expiry time,
b) the sample count is not met within a time window,
c) the LMF node (400) is unable to continue with the collection of the data samples due to one of excess load and congestion at the LMF node (400), and
d) the LMF node (400) is unable to one of: start and complete the collection of the data samples due to one of: an internal error and unspecified reasons.

15. The method as claimed in claim 14, wherein generating, by the LMF node (400), an error message comprising an error cause comprises one of:
a. determining that a current sample count at the LMF node (400) is less than the sample count requested in the service request after expiry of the subscription expiry time, and generating the error comprising the error cause indicating “the sample count is not met due to expiry of the subscription expiry time for the collection of the data samples”;
b. determining that a current sample count at the LMF node (400) is less than the sample count requested in the service request within the time window requested in the service request, and generating the error message comprising the error cause indicating “the sample count is not met within the time window”;
c. determining whether one of: an excess load and congestion at the LMF node (400) meets a threshold, and generating the error message comprising the error cause indicating “the LMF node (400) is unable to continue with the collection of the data samples due to excess load or congestion at the LMF node (400)”; and
d. detecting one of: an internal error and other unspecified errors at the LMF node (400), and generating the error message comprising the error cause indicating “the LMF node (400) is unable to start or continue with the collection of the data samples due to internal error or unspecified reasons”.

16. The method as claimed in claim 14, wherein each error cause is represented as an attribute “cause” in a data type “LmfDataExposureCause” present in the Nlmf_DataExposure API, and wherein the data type “LmfDataExposureCause” is updated to include additional error causes.

17. A Location Management Function (LMF) node (400) for performance monitoring of artificial intelligence ( ) or machine learning (AI/ML) based User Equipment (UE) Positioning in a telecommunication network (1000), comprising:
a memory (430);
a processor (420); and
a data samples collection controller (410), connected to the memory (430) and the processor (420), wherein the data samples collection controller (410):
receives a service request from a network node (500) to collect data samples by the LMF node (400) for training or performance monitoring of an AI/ML model, wherein the service request comprises a plurality of attributes, wherein the plurality of attributes comprises an area of interest from where the data samples are to be collected, and at least one of a periodicity attribute indicating at least one time interval during which the LMF node (400) shall initiate the collection of the data samples, a subscription expiry time indicating a time at which a subscription for the collection of the data samples expires, and a sample count indicating a number of data samples to be collected at every periodicity;
initiates the collection of the data samples in the area of interest based on the plurality of attributes;
detects an error when the LMF node (400) is unable to perform collection of data samples;
generates an error message comprising an error cause wherein the error cause depends on a type of the error; and
transmits the error message to the network node (500), wherein the error cause comprises at least one of:
a) the sample count is not met due to expiry of subscription expiry time,
b) the sample count is not met within a time window,
c) the LMF node (400) is unable to continue with the collection of the data samples due to one of excess load and congestion at the LMF node (400), and
d) the LMF node (400) is unable to one of: start and complete the collection of the data samples due to one of: an internal error and unspecified reasons.
